(19) United States
(12) Patent Application Publication
(10) Pub. No.: US 2016/0229704 A1
(43) Pub. Date: Aug. 11, 2016

(54) METHOD FOR MONITORING AND CONTROLLING FLUID FLOW IN A WATER TREATMENT SYSTEM

(71) Applicant: EcoWater Systems LLC, Woodbury, MN (US)

(72) Inventors: David Bardwell, Woodbury, MN (US); Keith Johnson, Woodbury, MN (US); Richard Kirchner, Apple Valley, MN (US); Vladislav Komlev, Woodbury, MN (US); Jeffrey Zimmerman, Forest Lake, MN (US)

(73) Assignee: EcoWater Systems LLC, Woodbury, MN (US)

(21) Appl. No.: 14/961,562

(22) Filed: Dec. 7, 2015

Related U.S. Application Data
(60) Provisional application No. 62/088,636, filed on Dec. 7, 2014.

(51) Int. Cl. C02F 1/00; G05B 15/02; H04L 29/08; C02F 1/42

(52) U.S. Cl. CPC C02F 1/008; C02F 1/42; G05B 15/02; H04L 67/02; C02F 2209/008; C02F 2209/40; C02F 2303/16

(57) ABSTRACT

A water treatment system, such as a water softener, is remotely operated and a method of remotely controlling a water treatment system. In a first embodiment, a method of detecting abnormal water usage within a water system associated with a water treatment system is provided. The method includes the steps of monitoring water usage associated with the water treatment system, determining whether the current water usage is above an alarm value, and sending an alarm notice in the event the current water usage is above the alarm value, and automatically taking predetermined action.

### CROSS-REFERENCE TO RELATED APPLICATION

This application claims the benefit of U.S. provisional application No. 62/088,636, filed Dec. 7, 2014, the contents of which are incorporated herein by reference.

### FIELD OF THE INVENTION

The present invention relates to water treatment systems in general and, in particular, a water softener which is remotely operated and a method of remotely controlling a water softener.

### BACKGROUND OF THE INVENTION

Water softening with ion exchange material, such as resin particles or the like, is well known in the art. During the softening process, typically called the service cycle, the ion exchange resin particles acquire hardness inducing ions from raw water which is being treated, in exchange for soft ions. That is, ions which do not induce hardness to water. After continued contact of the resin particles with hard raw water, the particles ion exchange capacity is considerably diminished and regeneration of the resin particles must be accomplished, conventionally by contacting the resin particles with a brine solution, i.e., an aqueous solution of sodium chloride or potassium chloride or the like, during a regeneration cycle.

The ion exchange process, which takes place during the regeneration of the ion exchange material, is accomplished in a softener or resin tank of well known construction. A separate brine tank is conventionally used to form brine for use during the regeneration cycle. When regeneration is initiated in the softener system, brine drawn from the brine tank passes through the bed of ion exchange material in the softener tank to reverse the exchange of ions and revitalize the bed by removing hardness inducing ions and replacing them with sodium ions, for example, from the brine.

As will be appreciated from the above, there is a substantial amount of water flowing into and out of a water softener. In the unlikely event of a leak or rupture within the plumbing in the water softener or in the household system, such as the main water line or the system for distributing the softened water, substantial cost and damage may be incurred if the leakage is not contained.

### SUMMARY OF THE INVENTION

The present invention provides various embodiments for controlling a water treatment system, such as a water softener.

In one embodiment, an electronic controller of a water softener is not provided with a web server. The water softener is connected to a remote main server via a LAN, such as the user's router/modem, or other internet connection. The user's PC and internet connection, such as a router/modem, may be located at the user softener installation site and, in fact, may be the same internet connection as used by the water softener. However, the user PC and internet connection may be located elsewhere. It will be appreciated that in this embodiment, the user is unable to communicate directly with the water softener via the user's web browser. Rather, the user's PC communicates with the remote main server via the user's web browser, mobile app, etc. to provide the desired user settings for the water softener. In one embodiment, the water softener polls the remote main server for updates from both the main server and from the user.

The water softener may have a universal serial bus (USB) or other interface to allow a dealer or other individual to connect a PC directly to the water softener for communication with or programming of the water softener, or for downloading of newer software versions.

Further, the water softener is provided with a valve controller. The valve controller includes a turbine located within a fluid flow path of the water softener, such as the inlet or outlet of the water softener. The turbine turns or rotates proportionally to the rate of fluid flow. An electronic controller such as that provided with the water softener, is capable of monitoring and detecting the rotational speed of the turbine. Thus, it is possible to calculate the flow rate based on monitoring the rotational speed of the turbine.

The water treatment system of the present invention is also equipped with one or more valves which may be actuated remotely. For example, one or more actuated valves may be located at the water softener inlet or outlet. Alternatively, the actuated valves may be incorporated in a traditional 3-valve type bypass or a traditional push-pull type bypass valve. In addition, or alternatively, one or more actuated valves may be located at the main water line entering the building where the water softener is located. The actuated valves may take various forms. In one embodiment, the actuated valve may be solenoid actuated valve. When a signal is applied to the coil of the solenoid, the valve is actuated to either the closed or open position. When another signal is applied to the solenoid coil, the valve is actuated to the opposite position. U.S. Pat. No. 5,152,321 is an example of a bypass valve and is incorporated herein by reference.

In another embodiment, the actuated valve is a motorized ball valve. One embodiment of a motorized ball valve is disclosed in U.S. Patent Application Publication No. 2010/0320152, which is incorporated herein by reference. In one embodiment of a motorized ball valve, the valve may have two positions which are 90 degrees apart from one another. A voltage is applied to the motor which rotates the ball valve from the first position to the second position. Upon reaching the second position, the ball valve will reach a switch state change position, which sends a signal to the controller. The controller then removes the voltage applied the motor. Another signal or voltage may be applied to the motor. The voltage will cause the motor to turn, urging the ball valve from the second position to the first position. Alternatively, another signal or voltage, such as one in opposite polarity from the first voltage, may be applied to the motor. The opposite polarity voltage will cause the motor to turn in an opposite direction, urging the ball valve from the second position to the first position. Upon reaching the first position, the ball valve will reach another switch state change position, associated with the first position, activating a switch which sends a signal to the controller. The controller then removes the voltage applied the motor.

The ball valve may take various forms. The ball valve may provide a fluid passage in the ball resembling a right angle. The right angle fluid passage may be used to provide a shut-off valve. In another embodiment, the fluid passage may resemble a T-shape. The T-shape flow path may provide the function of a bypass valve. For a bypass valve, depending on the application, it may be also advantageous when setting the ball valve to the bypass position for the electronic controller to move the valve rotor to a position to close the inlet or outlet of the softener controller, as appropriate.

The actuated valves may be hard wired to the controller of the water softener for control thereof. The controller of the water softener may be controlled via a main server located remotely from the water treatment system but via a local Ethernet or WiFi network. Alternatively, the actuated valves may have WiFi capability, allowing the actuated valve to be controlled directly via a WiFi network at the location of the water treatment system. The WiFi system may be integrated with the water treatment system and/or part of an overall household appliance control network.

It will be appreciated that the phrase personal computer or PC may include other devices, such as, but not intended to be limited thereto, a smart phone, internet tablet and other mobile devices. Further, such devices typically may include a web browser or similar application or feature. The phrases web browser and web server are intended to include other similar applications, respectively. U.S. Patent Application Publication N. 2003/0038839 discloses an example of a method for a web based service and U.S. Patent Application Publication No. 2005/0215244 discloses an example of a device and method for monitoring a meter, and are both incorporated herein by reference. In addition, it will be appreciated that the web server of the main server or the user PC may include an application programming interface for web services to allow application software, mobile application, or desktop widgets, or similar feature, to access the relevant data.

### BRIEF DESCRIPTION OF DRAWINGS

FIG. 1 is a schematic representation of an automatic water conditioning system of the general type which embodies the present invention, with one or more actuated valves.

FIG. 2 is a block diagram of a system including a water treatment system in accordance with one embodiment of the present invention.

FIG. 3 is a block diagram of the water treatment system of FIG. 2.

FIG. 4 depicts a screen shot during a user interaction with the remote main server.

FIG. 5 is a perspective view of a housing of a rotary valve controller of the softener and an example of an actuated ball valve at the inlet to the housing.

### DETAILED DESCRIPTION OF THE INVENTION

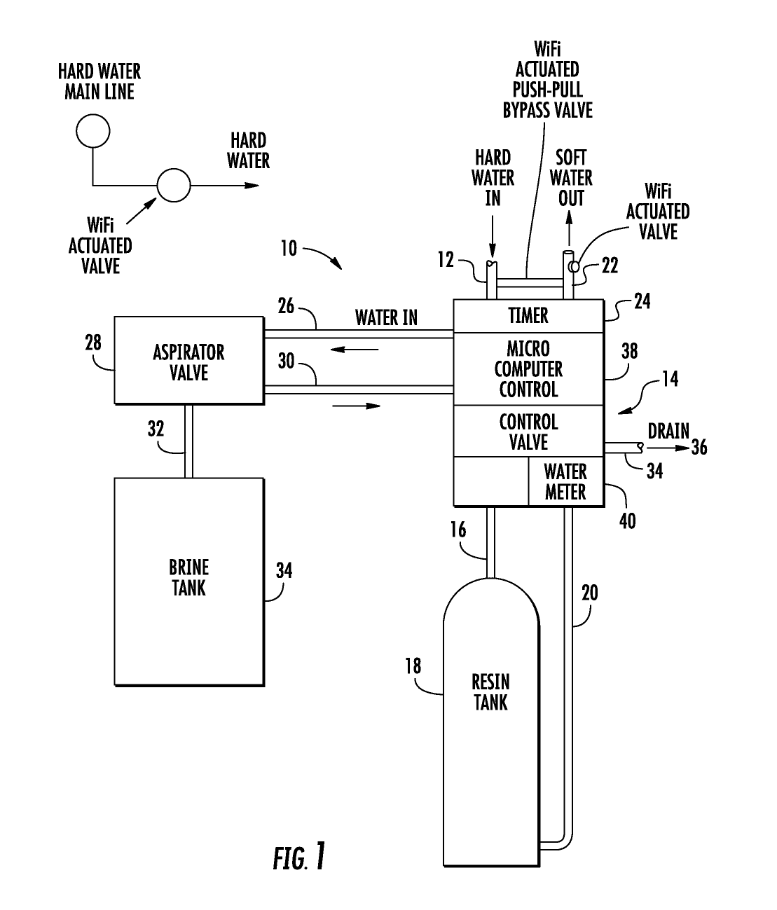

To assist in the understanding of the water softener regeneration control system of this invention, a schematic diagram of a water conditioning system of conventional construction as shown in FIG. 1 will be described. The system 10 is designed to soften water when it is delivered to a residence or business for use during what is typically called the “service cycle” of the system. Periodically the system 10 must be regenerated to restore its softening capability. The system 10 is regenerated by the use of a brine solution during a “regeneration cycle”. The present invention is concerned with the control of the regeneration cycle.

During a service cycle, raw or hard water is passed through a supply pipe 12 to a control valve 14. The control valve 14 supplies the raw water through a pipe 16 to a tank 18 which contains a bed of ion exchange resin particles. The raw water passes through the bed of resin and is withdrawn from the tank 18 through an outlet pipe 20. The water withdrawn through the outlet pipe 20, which has been softened by contact with the ion exchange resin again passes through the control valve 14 to a service pipe 22.

When the ion exchange resin losses its capacity to effectively soften the water passing through it, regeneration is necessary. A regeneration cycle typically includes cycles to backwash and rinse the resin. Those cycles are followed by a brine cycle during which a brine solution flows through the ion exchange resin particles. A timer 24 initiates the brine cycle by actuating the control valve 14 to direct water from the supply pipe 12 through a pipe 26 and aspirator valve 28 to pipe 30. The flow through pipe 30, which passes through control valve 14, is directed by the control valve to outlet pipe 20. The water from pipe 26 passing through the aspirator valve 28 creates a pressure reduction by Venturi effect in a pipe 32 which extends to near the bottom of a brine tank 34. Due to the pressure reduction, brine is drawn from the brine tank 34 through the pipe 32 and flows with the water through pipe 30, control valve 14, and pipe 20 to the bottom of resin tank 18. The flow of brine through the ion exchange resin particles removes the hardness creating ions and carries them, with the discharge water, through pipe 16, control valve 14 to a drain 36. The flow of water through pipe 26 as controlled by timer 24 is continued long enough to withdraw all of the brine available to the pipe 32 in the brine tank 34. Thereafter the control valve 14, stops the flow of water to pipe 26 from pipe 12, and instead directs it to outlet pipe 20 to backwash the ion exchange resin particles. Prior to the next regeneration cycle, water from the supply pipe 12 is directed by the control valve 14 to the brine tank 34 to create brine for the next regeneration cycle. In accordance with this invention, the softening system 10 also includes a microprocessor control 38 and a water meter 40.

FIG. 1 also shows a Wi-Fi actuated valve located at an outlet of the water softener. Alternatively, the Wi-Fi actuated valve may be located elsewhere such as at the inlet of the water softener. A Wi-Fi actuated valve is also shown at the main water inlet. In another embodiment, a Wi-Fi actuated valve is incorporated in a push-pull type bypass valve extending across the inlet and outlet of the water softener. U.S. Pat. No. 9,139,986 discloses one example of a Wi-Fi actuated valve and is incorporated herein by reference. In other embodiments, one or more of the actuated valves may be hardwired to the electronic controller for controlling the actuated valve rather than via a WiFi interface.

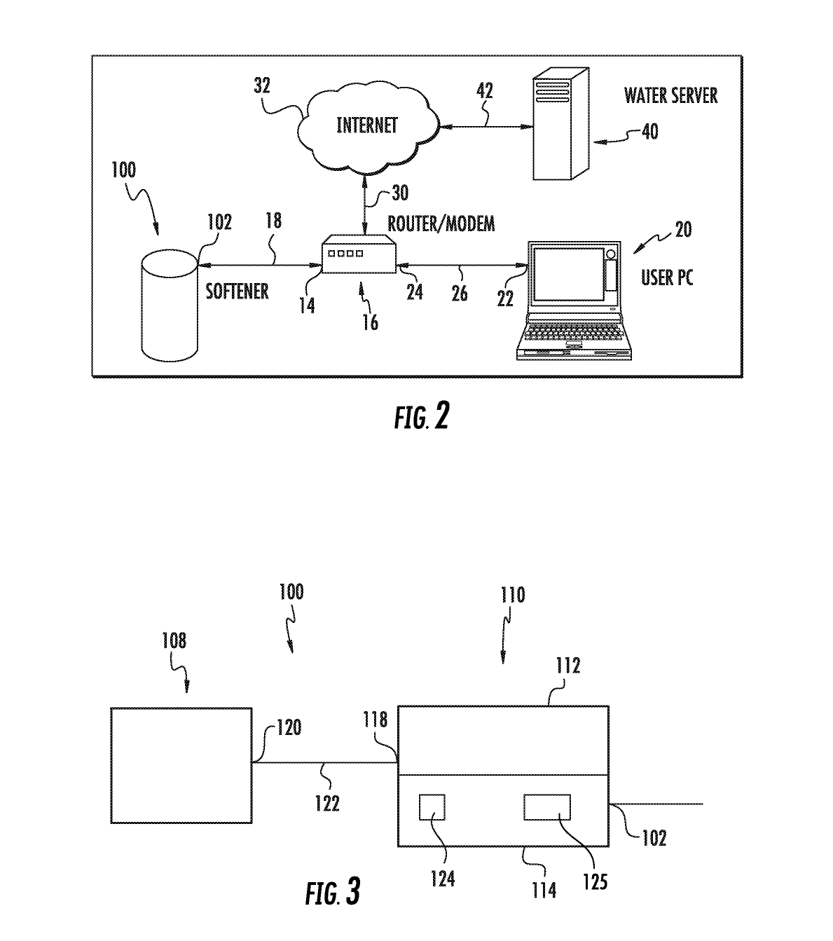

FIG. 2 discloses one example of the present invention. The following reference numerals refer to FIGS. 2 and 3 and not those of FIG. 1. The system includes a water softener system 100, having an Ethernet port 102 coupled to the Ethernet port 14 of a combination router/modem 16, via an Ethernet cable 18. A personal computer 20 includes an Ethernet port 22 coupled to an Ethernet port 24 of the router/modem 16, via an Ethernet cable 26. However, this embodiment does not require that the PC 20 couple to the internet via the same LAN or internet interface as the water softener system 100. The PC 20 includes web browser software capable of retrieving, presenting, and traversing information resources on the World Wide Web. It will be appreciated that the router/modem 16 may be coupled to the water softener system 100 or PC 20 via other interface devices, such as a USB or wireless connection, provided that the water softener system 100 or PC 20 are provided the appropriate corresponding interface, as is known in the art, such as a Wi-Fi adapter 125 (FIG. 3). The modem portion of the router/modem 16 may be a DSL modem or cable modem, or similar device. The combination router/modem 16 is shown as being coupled via a cable 30 to the internet 32, in a manner as known in the art. The combination router/modem 16 may also be comprised of separate components, rather than the combined system as shown, as is known in the art.

In the embodiment of FIG. 2, the water softener system 100 and router/modem 16 are located at the customer softener installation site. As suggested above, the PC 20 may or may not be located at the customer softener installation site. If the PC 20 is not located at the customer softener installation site, then the router function of the router/modem 16 may not be required. Further, another internet interface, such as a modem, will be required at the location of the PC 20 for coupling the PC 20 to the internet. In addition, a server 40 is shown and is at a location remote from the customer softener installation site. It is not likely, but not necessarily prohibited, that the server 40 and PC 20 would be at the same location. The server 40 is capable of communicating over the internet 32 via a connection 42 which may comprise any one of various methods as known in the art. Further, the server 40 includes web server software capable of delivering content, such as web pages, to a client, such as the PC 20. The content may be delivery of HTML documents. The server 40 further maintains records 44 of customers with various fields related to the customer data, equipment, and services. In addition, the server 40 may maintain other data 46, such as data on water hardness in specific locations, data regarding water containments identified in specific locations, and water usage by region or customer. In addition, preferably, the server 40 is associated with one or more URLs which are associated in name with the water treatment system and service provider, to provide a URL more readily recalled by the customer.

FIG. 3 is a block diagram of one example of the water treatment system 100 of FIG. 2. The water softener system 100 is shown to include a water softener 108 coupled to a control system 110. The control system 110 and water softener 108 may be a unitary system. Alternatively, the control system 110 may be separate from the water softener 108. In fact, it will be appreciated that the control system 110 might take the form of a personal computer, with the appropriate software installed. The control system 110 includes a controller 112 and communications interface device 114. The communications interface device 114 may optionally include a WiFi adapter 125. The controller 110 does not require web server software.

The controller system 110 includes a port 118 coupled to a port 120 of the water softener 108 via data and control lines 122. The controller 112 is capable of requesting and storing a local network IP address 124. The controller 112 or communications interface device 114 includes the MAC address, or similar unique identifier. A label with the unique identifier may be provided on the water treatment system 100. In any event, the unique identifier is provided with the system to associate the system with the customer. The communication interface device 114 also includes the Ethernet port 102.

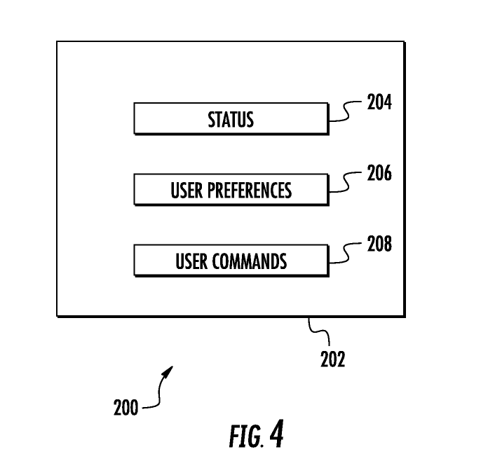

FIG. 4 depicts a screen shot 200 during a user interaction with the remote main server 40. The screen shot 200 is shown to include a dashboard user interface 202. The user interface 202 presents status information 204, as well as a user preferences interface 206 whereby the user may set various preferences for either of the remote main server 40 or softener controller, some of which may be action to take in the event of detecting certain events. In addition, user interface 202 includes a user commands interface 208 wherein, for example, the user may select or enter commands to be executed promptly.

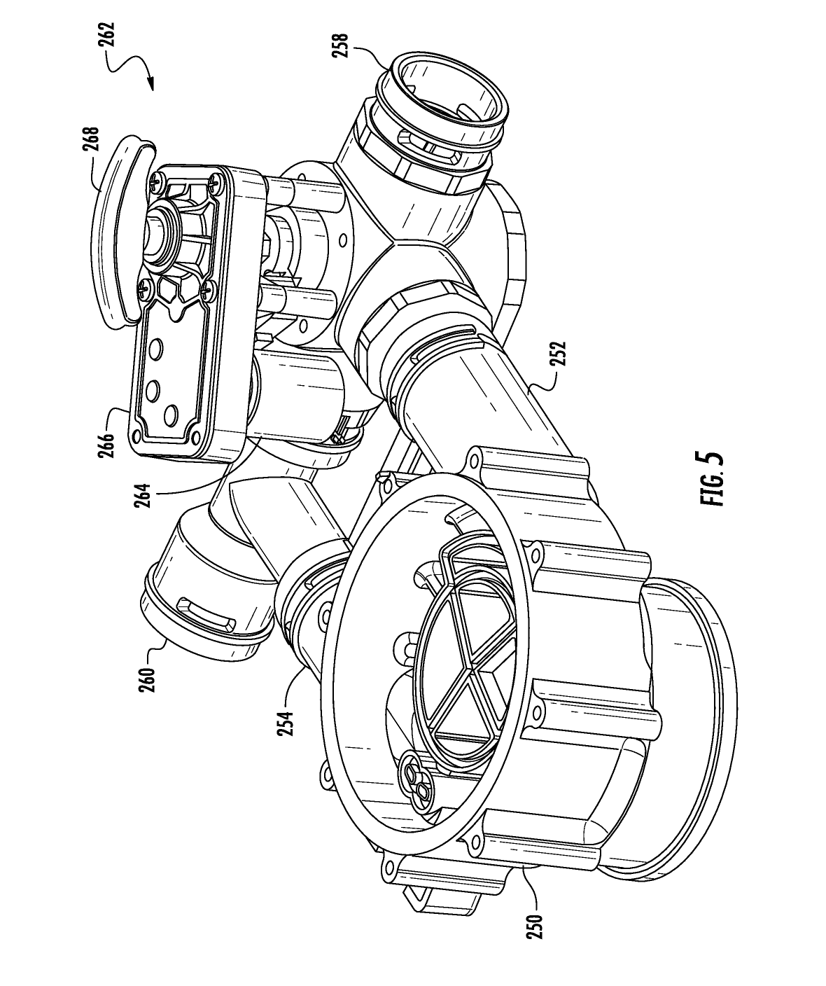

FIG. 5 is a perspective view of a housing 250 of a rotary valve controller of the softener. The housing 250 includes an inlet 252 and an outlet 254. Coupled across the inlet and outlet is a bypass valve 256. The bypass valve includes an inlet 258 for coupling to untreated water and an outlet 260 for coupling to the treated water service line. The bypass valve 256 includes an example of an actuated ball valve 262 at the inlet 252 to the housing 250. The ball valve 262 may include a ball (not shown) having a T-shaped fluid passage. The ball valve 262 includes an electric motor 264 and a mechanical and electrical controller 266 for moving the ball to the desired position. It will be appreciated that in the service position, a right angled portion of the T-shaped fluid passage couples the inlet 258 to the inlet 252 and blocks the inlet 258 from the outlet 260. In a bypass position, the ball is arranged so that the straight portion of the T-shaped fluid passage couples the inlet 258 to the outlet 260 and blocks the inlet 252.

The actuated ball valve 262 may be hard wired to the electronic controller of the water softener for control thereof based on predetermined events. The controller of the water softener may be controlled via a main server located remotely from the water treatment system but via a local Ethernet or WiFi network. Alternatively, the actuated ball valve 262 may have WiFi capability, allowing the actuated ball valve 262 to be controlled directly via a WiFi network at the location of the water treatment system. The WiFi system may be integrated with the water treatment system and/or part of an overall household appliance control network.

The ball valve 262 is also shown to include a handle 268 for manual control of the position of the ball. To operate the handle 268 the ball valve 262 may include a means to disengage the ball from control of the motor 264 and controller 266.

It should be apparent to those skilled in the art that what has been described is considered at present to be a preferred embodiment of the system and method. However, in accordance with the patent statutes, changes may be made in the system and method without actually departing from the true spirit and scope of this invention. The appended claims are intended to cover all such changes and modifications which fall within the true spirit and scope of this invention.

I claim:

1. A method of detecting abnormal water usage within a water system associated with a water softener system, the method comprising the steps of:
monitoring water usage associated with the water softener system;
determining whether the current water usage is above an alarm value;
initiating an alarm action in the event the current water usage is above the alarm value.

2. The method of claim 1, wherein the step of monitoring water usage includes monitoring the rotational speed of a turbine located within a fluid flow channel of the water softener system, converting the rotational speed of the turbine to the quantity of fluid passing through the fluid flow channel of the water softener system.

3. The method of claim 1, further comprising the step of maintaining a data base of water usage includes recording the water usage together with the respective date, time and the region the water softener system is located.

4. The method of claim 3, wherein the step of maintaining a data base of water usage includes maintaining the data base in a controller located at the water softener system or at main server at a location remote from the water softener system, wherein the step of maintaining a data base of water usage includes determining an alarm value based on the month, day and time, and adjusted by current regional water usage patterns, and recording the respective alarm values in the data base.

5. The method of claim 1, wherein the step of determining whether the current water usage is above an alarm value includes providing a current water usage and the respective month, day, time and region, to a controller located at the water softener system or a main server at a location remote from the water softener system and processing the current water usage and the respective month, day, time and region with an algorithm, comparing the current water usage to an alarm value corresponding to the respective month, day, time and region, the determining whether the current water usage is above an alarm value may be made at the main server or at the controller, and the alarm action may originate at the main server or at the controller.

6. The method of claim 1, wherein the step of initiating an alarm action in the event the current water usage is above the alarm value includes, sending an alarm notice from a main server at a location remote from the water softener, via email or text message to a user defined email address or SMS number or sending an alarm notice from the controller to an annunciator located on the water softener system or to a remote unit located at the site of the water softener system, whereby the user may take such action as desired.

7. The method of claim 1, further comprising the step of a main server at a location remote from the water softener, receiving user provided information requesting that the flow of water in the water system be closed, the main server providing a command to close a water flow control valve located within the water system of the water softener system, wherein the valve may be located at the water softener system or at a main water line of the location of the water softener system, and wherein the step of receiving user provided information comprising receiving the information from a user controlled app or web browser.

8. The method of claim 1, further comprising the step of receiving at a main server at a location remote from the water softener system, user provided information regarding control of the water softener, dispatching information from the main server to a controller located at the water softener regarding control of the water softener, wherein the information may be based in part upon the user provided information, wherein the step of receiving user provided information includes the main server presenting a dashboard user interface to the user, the dashboard user interface presenting various information to the user and requesting various information or selections from the user, including the presenting the status of the water softener system, requesting user preferences, user command options, main server action and water softener controller action based on user input parameters, including main server automatic alarm action and water softener controller automatic alarm action based on pre-determined user defined parameters upon the detection of a pre-determined event, such as abnormal water usage.

9. The method of claim 1, wherein upon initiating an alarm action causes the controller to automatically close one or more water valves, per previously designated user input information, wherein the one or more water valves may be one or more actuated valves located at least at one of the rotor of the softener rotary control valve, the inlet to the softener rotary control valve, the outlet to the softener rotary control valve, a main water line at the water softener location, push-pull bypass valve, or a three-way bypass valve.

10. The method of claim 9, further comprising receiving the previously designated user information at a main server located remote from the water softener system and from a user controlled app or web browser.

11. A method of controller a water softener system comprising the steps of:
receiving user provided request at the main server to activate a push-pull or three-way bypass valve at a water softener system;
the main server providing a command to the water softener system to activate the bypass valve, diverting the untreated water at the inlet of the water softener system directly to the outlet of the water softener system.

12. The method of claim 11, wherein the step of receiving the user provided request includes receiving user provided predetermined information as to the designated day and time to activate a bypass valve and de-activate the bypass valve.

13. The method of claim 11, wherein the step of receiving user provided request includes receiving the user request at a main server located remote from the water softener system and from a user controlled app or web browser.

14. A method of controller a water softener system comprising the steps of:
receiving user provided request at the main server to activate a bypass valve at a water softener system;
the main server providing a command to the water softener system to position a valve rotor of a water valve controller of the water softener system, to direct untreated water entering the water valve controller directly to an outlet of the water softener system, thus bypassing the water softener system and providing untreated water at the outlet of the water softener system.

15. The method of claim 14, wherein the step of receiving the user provided request includes receiving user provided predetermined information as to the designated day and time to position the valve rotor to direct untreated water to the outlet and to position the valve rotor to direct treated water to the outlet.

16. The method of claim 14, wherein the step of receiving user provided request includes receiving the user request at a main server located remote from the water softener system and from a user controlled app or web browser.

17. A system for carrying out the method of claims 1-16.
